(19) United States
(12) Patent Application Publication
(10) Pub. No.: US 2012/0273184 A1
(43) Pub. Date: Nov. 1, 2012

(54) FREEZING PROTECTION SYSTEM OF HEAT EXCHANGER AND METHOD FOR CONTROLLING THE SAME

(75) Inventor: Ji Seok YANG, Seoul (KR)

(73) Assignee: SUNG JI AIR-CONDITIONING TECHNOLOGY CO., LTD., Seoul (KR)

(21) Appl. No.: 13/358,120

(22) Filed: Jan. 25, 2012

(30) Foreign Application Priority Data
Apr. 27, 2011 (KR) 10-2011-0039433

(51) Int. Cl. F28F 27/00; G05D 23/00

(52) U.S. Cl. 165/278; 165/200; 165/287

(57) ABSTRACT

Disclosed is a freezing protection system of a heat exchanger capable of preventing freezing of a heat exchanger. The system includes a discharge valve for opening and closing a discharge pipe of a fluid inside a heat exchanger; a freezing factor detection unit for detecting a freezing factor such that the discharge pipe is open, under an automatic control of the discharge valve, upon detection of the freezing factor when the heat exchanger is in a standstill state; and a discharge completion detection unit for detecting whether the fluid inside the heat exchanger has been completely discharge or not, such that the open discharge valve is closed under an automatic control of the discharge valve after the fluid inside the heat exchanger has been completely discharged.

### BACKGROUND OF THE INVENTION

1. Field of the Invention

The present invention relates to a freezing protection system of a heat exchanger (or a cooling coil) capable of preventing freezing of a heat exchanger (or a cooling coil), and a method for controlling the same.

2. Background of the Invention

A heat exchanger (or a cooling coil) is an apparatus for heating or cooling the air, water, etc. by a heat exchange operation, and is mainly applied to an air conditioner, etc.

As a heating medium of the heat exchanger, a fluid such as water is mainly used. If a temperature around the heat exchanger is low when the heat exchanger is in a standstill state, the fluid inside the heat exchanger is frozen to cause a freezing accident of the heat exchanger.

In order to prevent a freezing accident of the heat exchanger, the fluid inside the heat exchanger has to be discharged when the heat exchanger is in a standstill state. Accordingly, required are researches on a method for easily discharging the fluid inside the heat exchanger when the heat exchanger is in a standstill state.

### SUMMARY OF THE INVENTION

Therefore, an aspect of the detailed description is to provide a freezing protection system of a heat exchanger (or a cooling coil) capable of preventing freezing of a heat exchanger (or a cooling coil) by automatically discharging a fluid inside the heat exchanger (or the cooling coil), a method for controlling the same.

To achieve these and other advantages and in accordance with the purpose of this specification, as embodied and broadly described herein, there is provided a freezing protection system of a heat exchanger, the system comprising: a discharge valve for opening and closing a discharge pipe of a fluid inside a heat exchanger; a freezing factor detection unit for detecting a freezing factor such that the discharge pipe is open under an automatic control of the discharge valve upon detection of the freezing factor when the heat exchanger is in a standstill state; and a discharge completion detection unit for detecting whether the fluid inside the heat exchanger has been completely discharge or not, such that the open discharge valve is closed under an automatic control of the discharge valve after the fluid inside the heat exchanger has been completely discharged.

The freezing protection system of a heat exchanger may further comprise a ventilation unit for ventilating the heat exchanger when the fluid inside the heat exchanger is discharged.

The ventilation unit may further include an air vent valve configured to be open such that the inside of the heat exchanger is ventilated when the fluid inside the heat exchanger is discharged.

To the heat exchanger, may be connected an inlet circulation pipe and an outlet circulation pipe through which the fluid for a heat exchange operation is introduced into or discharged from the heat exchanger.

The inlet circulation pipe and the outlet circulation pipe may be installed with an inlet blocking valve and an outlet blocking valve, respectively.

The air vent valve may be connected to one of the inlet circulation pipe and the outlet circulation pipe.

The discharge valve may be connected to one of the inlet circulation pipe and the outlet circulation valve, the one to which the air vent valve has not been connected.

The discharge completion detection unit may include a heat exchanger inner pressure sensor for sensing an inner pressure of the heat exchanger in order to determine whether the fluid inside the heat exchanger has been completely discharged, by comparing the inner pressure of the heat exchanger with an atmospheric pressure when the fluid is discharged.

The discharge completion detection unit may further include a heat exchanger weight sensor for sensing a weight of the heat exchanger in order to determine, based on the weight of the heat exchanger, whether the fluid inside the heat exchanger has been completely discharged.

The discharge completion detection unit may include a level sensor for detecting a discharge flow of the fluid inside the heat exchanger.

The freezing factor detection unit may include a heat exchanger temperature sensor for sensing at least one of an inner temperature and an outer temperature of the heat exchanger.

The freezing protection system of a heat exchanger may further comprise a charging unit for supplying compressed air into the heat exchanger for ventilation, or charging a fluid in the heat exchanger for an operation of the heat exchanger.

The discharge valve may be configured as an automatic control valve configured to be automatically controlled when the system is in an on state, but to close the discharge pipe when the system is in an off state.

The freezing protection system of a heat exchanger may further comprise a second discharge pipe connected to the discharge pipe, and configured to guide discharge of the fluid inside the heat exchanger; a temperature valve installed at the second discharge pipe, configured to open the second discharge pipe when a temperature is low, and configured to restore the original state by being manually operated such that the open second discharge pipe is closed; and an electronic valve installed at the second discharge valve below the temperature valve in a discharge direction of the second discharge valve, and set to close the second discharge pipe when being supplied with power but to open the second discharge pipe when the power supply is interrupted.

To achieve these and other advantages and in accordance with the purpose of this specification, as embodied and broadly described herein, there is also provided a method for controlling a freezing protection system of a heat exchanger, the method comprising: a circulation pipe closing step of closing a circulation pipe of a fluid inside a heat exchanger upon detection of a freezing factor of the heat exchanger, the fluid for a heat exchange operation; a discharge pipe opening step of opening a discharge pipe such that the fluid inside the heat exchanger is discharged through the discharge pipe; a differential pressure detecting step of firstly detecting a differential pressure between an inner temperature of the heat exchanger and an atmospheric pressure, and secondly detecting a differential pressure between an inner temperature of the heat exchanger and an atmospheric pressure, after a predetermined time has lapsed, when the firstly-detected differential pressure is less than a first reference value; a ventilation step of ventilating the heat exchanger by supplying gas into the heat exchanger, when the secondarily-detected differential pressure is more than a second reference greater than the first reference value; a ventilation halt step of halting the ventilation when a thirdly-detected differential pressure between an inner temperature of the heat exchanger and an atmospheric pressure is less than a third reference value, or when a predetermined time long enough to perform the ventilation has lapsed; and a discharge pipe closing step of fourthly detecting a differential pressure between an inner temperature of the heat exchanger and an atmospheric pressure, after a predetermined time has lapsed after the ventilation halt step, and closing the discharge pipe open in the discharge pipe opening step when the fourthly-detected differential pressure is less than a fourth reference value.

The heat exchanger may be configured as a cooling coil for removing waste heat and preventing a plume phenomenon.

To achieve these and other advantages and in accordance with the purpose of this specification, as embodied and broadly described herein, there are still also provided an air conditioner having the freezing protection system of a heat exchanger, and a cooling tower having the freezing protection system of a heat exchanger, the cooling tower where the heat exchanger is configured as a cooling coil.

The present invention may have the following effects. However, the present invention may be implemented with any of the following effects.

Firstly, when the heat exchanger (or the cooling coil) is in a standstill state, the fluid inside the heat exchanger may be automatically discharged. This may allow the fluid inside the heat exchanger to be discharged before the occurrence of freezing of the heat exchanger only when there is a possibility of freezing of the heat exchanger. Accordingly, a user may not be required to pay attention for prevention of freezing when the heat exchanger is in a standstill state, and the occurrence of freezing may be prevented.

Secondly, whether the fluid inside the heat exchanger has been completely discharged may be detected based on a differential pressure between an inner pressure of the heat exchanger and an atmospheric pressure, or based on a weight of the heat exchanger. Accordingly, whether the fluid inside the heat exchanger has been completely discharged or not may be detected, without requiring a user's check using his or her naked eyes.

Thirdly, the fluid inside the heat exchanger may be discharged through the second discharge pipe open and closed by the temperature valve when the system is in an off state. This may prevent the occurrence of freezing even when the system is in an off state.

Fourthly, when the system is again in an on state after being in an off state, the second discharge pipe may be closed by the electronic valve installed thereat, even if the temperature valve maintains the state to open the second discharge valve. This may allow a fluid to be automatically filled in the heat exchanger. Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a configuration view showing a fluid discharging operation in a freezing protection system of a heat exchanger according to a first embodiment of the present invention;

FIG. 2 is a configuration view showing a fluid charging operation in a freezing protection system of a heat exchanger according to a first embodiment of the present invention;

FIG. 3 is a flowchart showing a method for controlling a freezing protection system of a heat exchanger according to a first embodiment of the present invention;

FIG. 4 is a configuration view showing a fluid discharged state when a freezing protection system of a heat exchanger according to a second embodiment of the present invention is in an on state;

FIG. 5 is a configuration view showing a fluid filled state when a freezing protection system of a heat exchanger according to a second embodiment of the present invention is in an on state;

FIG. 6 is a configuration view showing a fluid discharged state when a freezing protection system of a heat exchanger according to a second embodiment of the present invention is in an off state; and

FIG. 7 is a configuration view showing a fluid filled state when a freezing protection system of a heat exchanger according to a second embodiment of the present invention is again in an on state after being in an off state.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

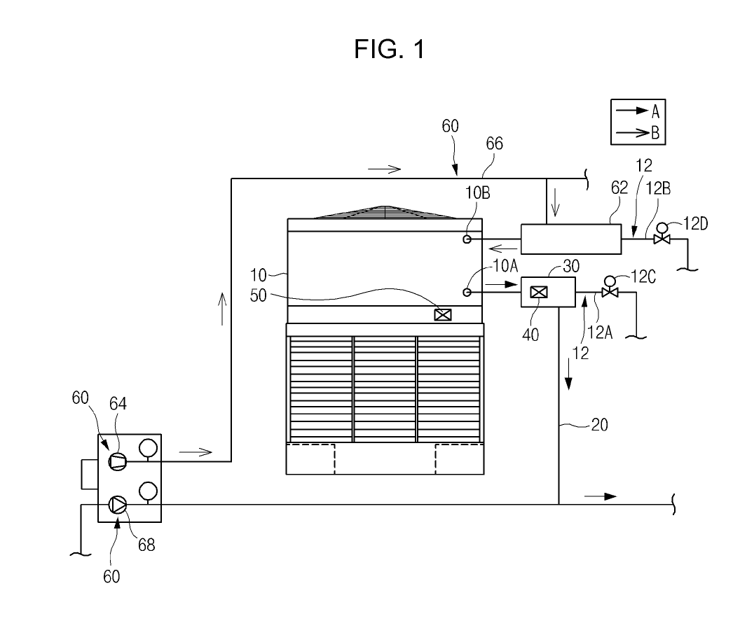

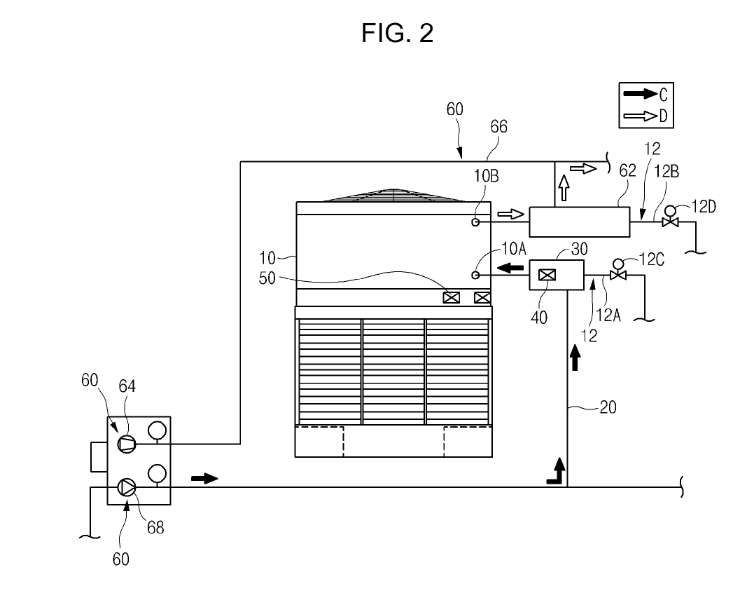

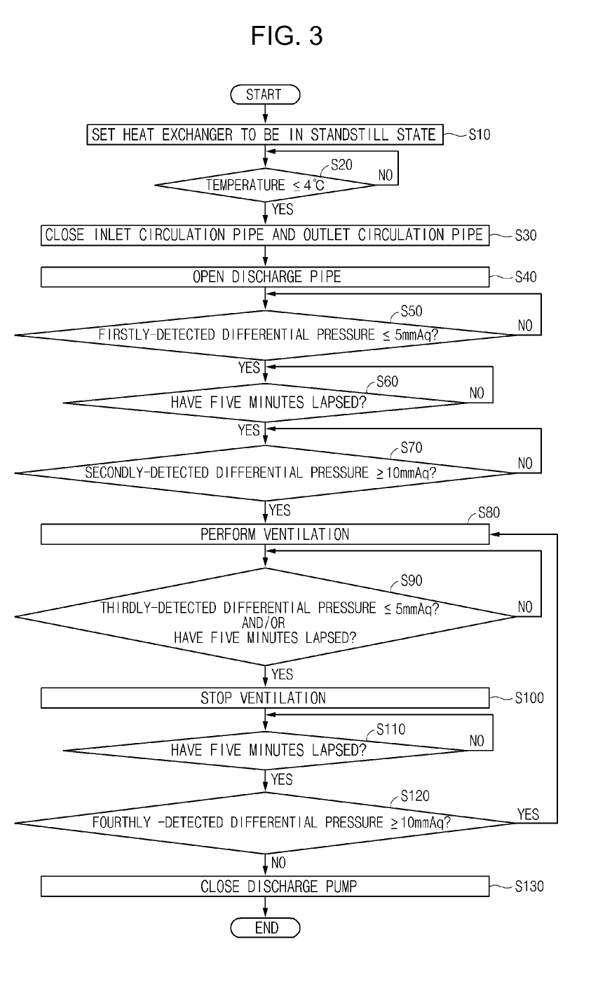

FIG. 1 is a configuration view showing a fluid discharging operation in a freezing protection system of a heat exchanger according to a first embodiment of the present invention, FIG. 2 is a configuration view showing a fluid charging operation in a freezing protection system of a heat exchanger according to a first embodiment of the present invention, and FIG. 3 is a flowchart showing a method for controlling a freezing protection system of a heat exchanger according to a first embodiment of the present invention.

As shown in FIGS. 1 and 2, the freezing protection system of a heat exchanger according to the present invention comprises a discharge valve 30 for opening and closing a discharge pipe 20 of a fluid inside a heat exchanger 10, a freezing factor detection unit 40 for detecting a freezing factor so that the discharge pipe 20 can be open under an automatic control of the discharge valve 30 upon detection of the freezing factor when the heat exchanger 10 is in a standstill state, and a discharge completion detection unit 50 for detecting whether the fluid inside the heat exchanger 10 has been completely discharge or not, so that the open discharge valve 20 can be closed under an automatic control of the discharge valve 30 after the fluid inside the heat exchanger 10 has been completely discharged.

One side of the discharge pipe 20 may be directly connected to one side of the heat exchanger 10, or may be connected to one side of a circulation pipe 12 through which a fluid circulates for a heat exchange operation of the heat exchanger 10.

For instance, the circulation pipe 12 may include an inlet circulation pipe 12A connected to an inlet 10A of the heat exchanger 10 so that a fluid can be introduced into the heat exchanger 10 therethrough, and an outlet circulation pipe 12B connected to an outlet 10B of the heat exchanger 10 so that the introduced fluid can be discharged from the heat exchanger 10 therethrough. The inlet circulation pipe 12A and the outlet circulation pipe 12B may be installed with an inlet blocking valve 12C and an outlet blocking valve 12D, respectively, so that the circulation pipe 12 can be closed in preparation for a discharge process, etc. for preventing freezing of the heat exchanger 10. In this case, the discharge pipe 20 may be connected to the inlet circulation pipe 12A between the inlet 10A of the heat exchanger 10 and the inlet blocking valve 12C as shown. Alternatively, although not shown, the discharge pipe 20 may be connected to the outlet circulation pipe 12B between the outlet 10B of the heat exchanger 10 and the outlet blocking valve 12D.

Another side of the discharge pipe 20 may be connected to a discharge pump (not shown) for pumping a fluid inside the heat exchanger 10 so as to smoothly discharge the fluid. The discharge pipe 20 may be installed so that the fluid discharged from the heat exchanger 10 can be directly discharged out through a discharge opening, etc. Alternatively, the discharge pipe 20 may be installed so that the fluid discharged from the heat exchanger 10 can be temporarily stored in a storage tank additionally installed at an indoor room, etc.

The discharge valve 30 may be configured as a two-way motor type automatic control valve for opening and closing the discharge pipe 20 by being automatically controlled when the freezing protection system is in an on state. The discharge valve 30 may be set to be in a state for closing the discharge pipe 20 when power supply thereto is interrupted, i.e., the freezing protection system is in an off state. The discharge valve, the automatic control valve is already well-known, and the present invention does not relate to a structure of the automatic control valve. Accordingly, detailed explanations of the automatic control valve will be omitted.

As shown, the discharge valve 30 may be installed at a connection part between the discharge pipe 20 and the inlet circulation pipe 12A. In a case that the discharge pipe 30 is connected to the outlet circulation pipe 12B, the discharge pipe 30 may be installed at a connection part between the discharge pipe 20 and the outlet circulation pipe 12B.

The freezing factor detection unit 40 is configured to detect a factor of freezing, especially, a temperature. Generally, freezing results from a low temperature. The freezing factor detection unit 40 is capable of detecting a possibility of the occurrence of freezing before freezing actually occurs, by easily and precisely detecting a temperature. More concretely, the freezing factor detection unit 40 may include a heat exchanger temperature sensor for sensing one of an inner temperature and an outer temperature of the heat exchanger 10.

The discharge completion detection unit 50 is configured to detect whether the fluid inside the heat exchanger 10 has been completely discharge. For a precise and easy detection in an automatic manner, the discharge completion detection unit 50 is preferably implemented as follows.

Firstly, the discharge completion detection unit 50 may include a heat exchanger inner pressure sensor for sensing an inner pressure of the heat exchanger 10 in order to determine whether the fluid inside the heat exchanger 10 has been completely discharged, by comparing the inner pressure of the heat exchanger 10 with an atmospheric pressure when the fluid is discharged.

More concretely, when ventilation is performed at an air vent valve 62 by a ventilation unit toward the discharge valve 30 during a discharge process of the fluid inside the heat exchanger 10, an inner pressure of the heat exchanger 10 increases due to a ventilation resistance by the fluid inside the heat exchanger 10. As the fluid inside the heat exchanger 10 is more performed, the amount of the fluid remaining in the heat exchanger 10 deceases to lower the inner pressure of the heat exchanger 10. If the ventilation is smoothly performed in the heat exchanger 10 without a resistance by the fluid, the inner pressure of the heat exchanger 10 detected by the heat exchanger inner pressure sensor reaches an atmospheric pressure. If the inner pressure of the heat exchanger 10 detected by the heat exchanger inner pressure sensor has reached an atmospheric pressure, or a differential pressure between the inner pressure of the heat exchanger 10 and the atmospheric pressure is within a predetermined range, it is determined that the fluid inside the heat exchanger 10 has been completely discharged.

The heat exchanger inner pressure sensor may be installed in the heat exchanger 10, or may be installed at the air vent valve 62 or the outlet 10B of the heat exchanger 10 so as to sense a pressure by a load of air sucked through the air vent valve 62. Alternatively, the heat exchanger inner pressure sensor may be installed at the discharge valve 30 or the inlet 10A of the heat exchanger 10 so as to sense a pressure by a load of air exhausted through the discharge valve 30.

Secondly, the discharge completion detection unit 50 may further include a heat exchanger weight sensor for sensing a weight of the heat exchanger 10 in order to determine, based on the weight of the heat exchanger 10, whether the fluid inside the heat exchanger has been completely discharged.

More concretely, the heat exchanger weight sensor is configured to detect not only a weight of the heat exchanger 10, but also a weight of each component attached to the heat exchanger 10 and a weight of the fluid inside the heat exchanger 10. If the fluid inside the heat exchanger 10 is discharged through the discharge pipe 20, the weight of the heat exchanger 10 detected by the heat exchanger weight sensor is reduced. Accordingly, if the weight of the heat exchanger 10 detected by the heat exchanger weight sensor has reached an initial value where the weight of the fluid is not included in the entire weight of the heat exchanger 10, it means that the fluid inside the heat exchanger 10 has been completely discharged.

Thirdly, the discharge completion detection unit 50 may further include a level sensor installed at the discharge valve 30 and configured to detect a discharge flow of the fluid inside the heat exchanger 10. More concretely, whether the fluid flows or not may be determined based on a fluid level detected by the level sensor. If the fluid level is about ‘0’ as a result of the detection by the level sensor, there is no flows of the fluid. This may mean that the fluid inside the heat exchanger has been completely discharged.

The discharge completion detection unit 50 may be configured to adopt a method using a differential pressure between an inner pressure of the heat exchanger 10 and an atmospheric pressure, and a method using a weight of the heat exchanger 10. Alternatively, the discharge completion detection unit 50 may be configured to adopt a method using the differential pressure and the weight of the heat exchanger 10 in a combined manner.

The freezing protection system of a heat exchanger may further comprise a charging unit 60 for supplying compressed air into the heat exchanger 10 for ventilation of the heat exchanger 10 so that the fluid inside the heat exchanger 10 can be discharged without a resistance in a vacuum state inside the heat exchanger 10, or for charging a fluid in the heat exchanger 10 so that the heat exchanger 10 can be driven for a heat exchange operation after the fluid has been discharged out.

The charging unit 60 may serve as a ventilation unit for ventilation of the heat exchanger 10. And, the charging unit 60 may include an air vent valve 62 configured to be open for ventilation of the heat exchanger 10 so that the inside of the heat exchanger 10 can not be in a vacuum state, in a state that the inlet circulation pipe 12A and the outlet circulation pipe 12B have been blocked by the inlet blocking valve 12C and the outlet blocking valve 12D. Here, the air vent valve 62 is also configured to be closed for prevention ventilation of the heat exchanger 10 after the fluid inside the heat exchanger 10 has been discharged.

The air vent valve 62 may be connected to one of the inlet circulation pipe 12A and the outlet circulation pipe 12B in a reverse manner to the discharge valve 30, so that air can be sucked into the heat exchanger 10 through the air vent valve 62, and air can be exhausted from the heat exchanger 10 through the discharge pipe 20. More concretely, when the discharge valve 30 is connected to the inlet circulation pipe 12A, the air vent valve 62 may be connected to the outlet circulation pipe 12B between the inlet 10A of the heat exchanger 10 and the outlet blocking valve 12D.

The charging unit 60, serving as a ventilation unit may be configured to supply gas of a high pressure to the heat exchanger 10 so that the fluid inside the heat exchanger 10 can be more smoothly discharged by a ventilation pressure, since ventilation is performed at the air vent valve 62 toward the discharge valve 30.

That is, the charging unit 60 may include a gas storage tank where gas of a high pressure has been stored, or a gas compressor 64 for compressing gas and supplying the compresses gas to the heat exchanger 10. The gas storage tank or the gas compressor 64 may be connected to the air vent valve 62 through a gas supply pipe 66.

As the gas supplied by the charging unit 60, air may be used for facilitation. Alternatively, may be used gas such as nitrogen harmless to a heat exchange operation of the heat exchanger 10, and configured to allow the fluid inside the heat exchanger 10 to be discharged.

The charging unit 60 may have a function of a fluid charging unit for automatically re-charging a fluid into the heat exchanger 10, so that the heat exchanger 10 can normally perform a heat exchange operation after the fluid inside the heat exchanger 10 has been discharged by the freezing protection system of the present invention.

As the charging unit 60, may be used any device capable of re-filing a fluid into the heat exchanger 10. For instance, the charging unit 60 may include a fluid charging pump 68 connected to the discharge pipe 20 so that a fluid can be filled through the discharge pipe 20. The fluid charging pump 68 may operate to allow a fluid to be re-filled in the heat exchanger 10 if it is determined that there is no possibility of the occurrence of freezing as a detection result by the freezing factor detection unit 40. Alternatively, the fluid charging pump 68 may operate so that a fluid can be filled in the heat exchanger 10 when a command for a heat exchange operation of the heat exchanger 10 has been input, or when the freezing protection system is in a standby state. Here, the fluid charging pump 68 may be separately configured from the discharge pump. Alternatively, the discharge pump may be configured as a two-way pump for performing both a discharge function and a charging function. In this case, the discharge pump may serve as the fluid charging pump 68.

An operation of the freezing protection system of the heat exchanger 10 according to the present invention will be explained with reference to FIGS. 1 to 4.

As shown in FIGS. 1 and 3, the freezing protection system is made to be in an on state while the heat exchanger 10 is in a standstill state (S10). Then, the occurrence of freezing is predicted according to whether the freezing factor detection unit 40 has detected a freezing factor (S20).

More concretely, an inner temperature of the heat exchanger 10, or a temperature of a fluid inside the heat exchanger 10, or an outer temperature of the heat exchanger 10, each sensed by the heat exchanger temperature sensor may be compared with preset temperatures, reference temperatures of the occurrence of freezing. For instance, as shown in FIG. 3, the temperature of the fluid inside the heat exchanger 10 may be compared with a preset temperature, 4 □. In this case, if the temperature of the fluid inside the heat exchanger 10 is less than 4 □, it may be determined that a freezing factor has been detected.

For reference, the standstill state of the heat exchanger 10 indicates a state that a fluid for a heat exchange operation of the heat exchanger 10 stops circulating, and a state that a compressor for circulating a fluid for a heat exchange operation of the heat exchanger 10, or a cold water pump, a fan, a cooling tower, etc. stops operating.

Upon detection of a freezing factor, the circulation pipe 12 of the fluid inside the heat exchanger 10, the fluid for a heat exchange operation of the heat exchanger 10 may be closed (S30). That is, the inlet circulation pipe 12A and the outlet circulation pipe 12B may be closed by the inlet blocking valve 12C and the outlet blocking valve 12D, respectively so that the fluid cannot circulate through the inlet circulation pipe 12A and the outlet circulation pipe 12B.

Then, the fluid inside the heat exchanger 10 is discharged through the discharge pipe 20 (S40).

That is, as the discharge pipe 20 is open by the discharge valve 30 and the discharge pump is driven, the fluid inside the heat exchanger 10 may be discharged through the discharge pipe 20 as indicated by the arrow of ‘A’ in FIG. 1.

Once the discharge pipe 20 is open, the charging unit 60 may start to operate for ventilation of the heat exchanger 10.

The charging unit 60 may be controlled as follows so that the heat exchanger 10 can be ventilated when a discharge resistance of the fluid inside the heat exchanger 10 becomes large.

More concretely, after the discharge pipe 20 has been open, a differential pressure between an inner pressure of the heat exchanger 10 and an atmospheric pressure is firstly detected, and then is compared with a first reference value (e.g., 5 mmAq) by which it is determined whether the inside of the heat exchanger 10 is in a vacuum state (S50). Here, the inner pressure of the heat exchanger 10 may be detected by the heat exchanger inner pressure sensor of the discharge completion detection unit 50.

If the firstly-detected differential pressure is less than the first reference value as a result of the comparison, it is determined that the inside of the heat exchanger 10 is nearly in a vacuum state. Then, it is determined whether a predetermined time (e.g., five minutes) has lapsed, the predetermined time for which the discharge resistance of the fluid inside the heat exchanger 10 may become large (S60). If the predetermined time has lapsed, a differential pressure between an inner pressure of the heat exchanger 10 and an atmospheric pressure is secondarily detected, and then is compared with a second reference value (e.g., 10 mmAq) by which it is determined whether the inside of the heat exchanger 10 is in a vacuum state (S70).

If the secondarily-detected differential pressure is more than the second reference value as a result of the comparison, it is determined that the inside of the heat exchanger 10 is in a vacuum state, and the charging unit 60 performs ventilation (S80).

More concretely, as the gas supply pipe 66 is open by the air vent valve 62 and the gas compressor 64 is driven, the inside of the heat exchanger 10 may be ventilated by the ventilation unit as indicated by the arrow of ‘B’ in FIG. 1.

After the heat exchanger 10 has started to be ventilated, it is determined whether the current condition satisfies a ventilation stopping condition (S90).

For instance, the ventilation stopping condition may be one of a condition that a thirdly-detected differential pressure between an inner pressure of the heat exchanger 10 and an atmospheric pressure is less than a third reference value (e.g., 10 mmAq) by which ventilation is stopped, and a condition that a predetermined sufficient time (e.g., five minutes) has lapsed.

Once the ventilation stopping condition has been satisfied, the ventilation by the charging unit 60 may be stopped. That is, the gas supply pipe 66 may be closed by the air vent valve 62 and the gas compressor 64 may be stopped (S100).

After the ventilation of the heat exchanger 10 has been stopped, it is determined whether a predetermined time (about 15 minutes) has lapsed, the predetermined time for which the fluid inside the heat exchanger 10 may be completely discharged out (S110). If the predetermined time has lapsed, it is determined, by the discharge completion detection unit 50, whether the fluid inside the heat exchanger 10 has been completely discharged.

For instance, if the discharge completion detection unit 50 is configured as the heat exchanger inner pressure sensor, a differential pressure between an inner pressure of the heat exchanger 10 and an atmospheric pressure is fourthly-detected. Then, the fourthly-detected differential pressure is compared with a fourth reference value (e.g., 10 mmAq) by which it is determined whether the fluid inside the heat exchanger 10 has been completely discharged (S120). If the fourthly-detected differential pressure is not more than the fourth reference value as a result of the comparison, it is determined that the fluid inside the heat exchanger 10 has been completely discharged.

If it is determined, by the discharge completion detection unit 50, that the fluid inside the heat exchanger 10 has been completely discharged, the discharge pipe 20 is closed again by the discharge valve 30, and the discharge pump is stopped to halt the discharge of the fluid inside the heat exchanger 10 (S130). And, the freezing protection operation by the freezing protection system of the present invention may be ended.

If the fourthly-detected differential pressure is more than the fourth reference value as a result of the comparison, it is determined that the fluid inside the heat exchanger 10 has not been completely discharged. And, the charging unit 60 performs a function of the ventilation unit, and the fluid inside the heat exchanger 10 is continuously discharged (S80˜S120).

Once the fluid inside the heat exchanger 10 starts to be discharged, the discharge may be informed by an alarm, etc. If power supply to the freezing protection system of the present invention is interrupted, the freezing protection system of the present invention may be driven by an auxiliary power. In this case, the freezing protection system may be configured to have a back-up function for back-up of a system function, data, etc.

In the present invention, the fluid inside the heat exchanger 10 is automatically discharged when the heat exchanger is in a standstill state. Accordingly, only when there is a possibility of freezing of the heat exchanger 10, the fluid inside the heat exchanger 10 is discharged before freezing of the heat exchanger actually occurs. This may allow a user not to pay attention to a freezing accident when the heat exchanger 10 is in a standstill state, and may prevent a freezing accident of the heat exchanger 10. Furthermore, whether the fluid inside the heat exchanger 10 has been completely discharged may be determined without a user's check with his or her naked eyes.

As shown in FIG. 2, once a driving signal for a heat exchange operation of the heat exchanger 10 is input in a state that the freezing protection system of the present invention is in an on state, the fluid charging pump 68 of the charging unit 60 is driven. And, a fluid may be re-filled in the heat exchanger 10 through the discharge pipe 20 as indicated by the arrow of ‘C’ in FIG. 2.

If an inner pressure of the heat exchanger 10 is more than a reference value after the fluid charging pump 68 was driven, it is determined that the fluid has been sufficiently filled in the heat exchanger 10. the reference value by which it is determined whether to re-fill a fluid or not, Accordingly, the operation of the fluid charging pump 68 may be stopped.

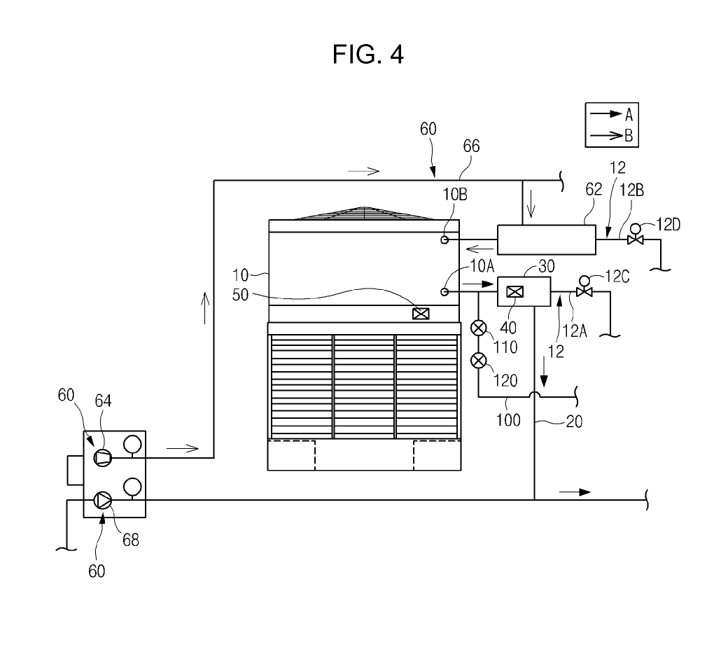

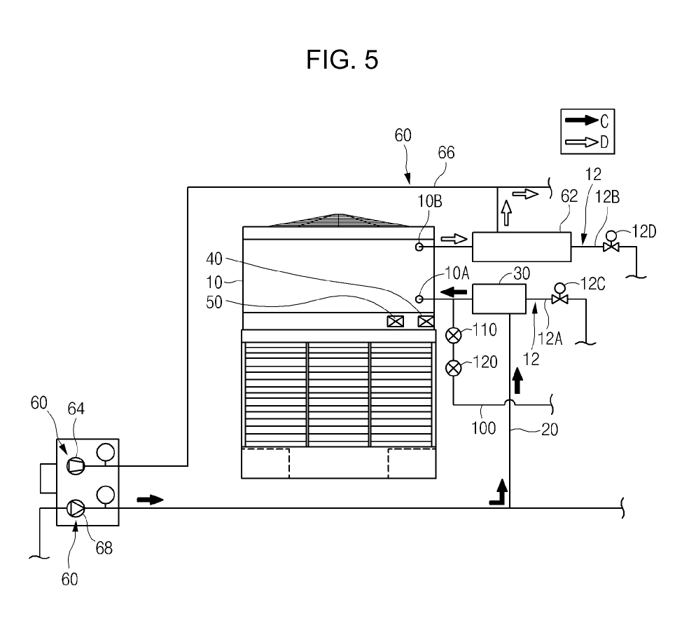

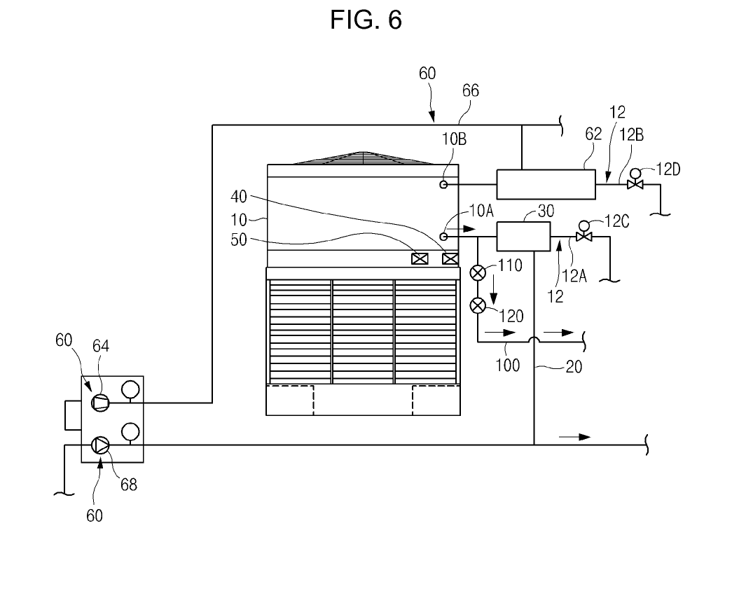

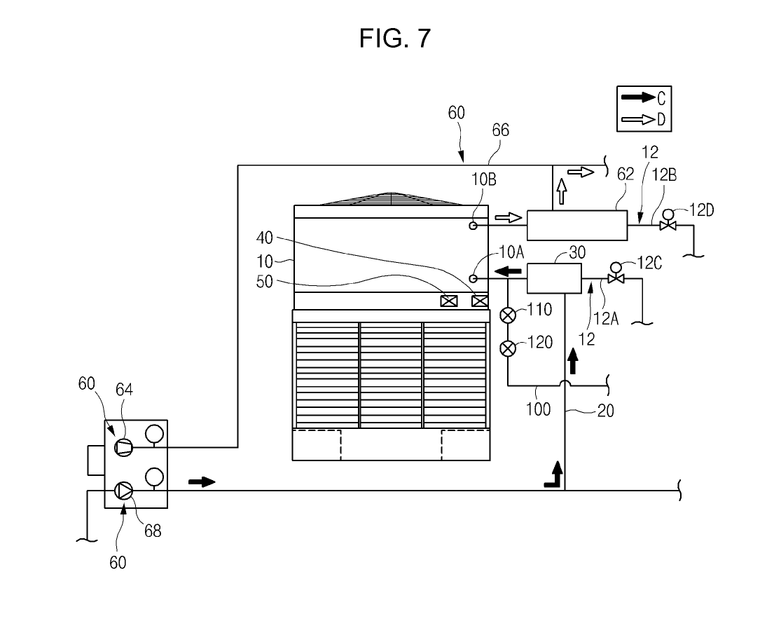

FIG. 4 is a configuration view showing a fluid discharged state when a freezing protection system of a heat exchanger according to a second embodiment of the present invention is in an on state, FIG. 5 is a configuration view showing a fluid filled state when a freezing protection system of a heat exchanger according to a second embodiment of the present invention is in an on state, FIG. 6 is a configuration view showing a fluid discharged state when a freezing protection system of a heat exchanger according to a second embodiment of the present invention is in an off state, and FIG. 7 is a configuration view showing a fluid filled state when a freezing protection system of a heat exchanger according to a second embodiment of the present invention is again in an on state after being in an off state.

As shown in FIGS. 4 to 7, the freezing protection system of a heat exchanger according to a second embodiment of the present invention may further comprise a second discharge pipe 100 connected to the discharge pipe 20, and configured to guide discharge of the fluid inside the heat exchanger 10, a temperature valve 110 installed at the second discharge pipe 100, configured to open the second discharge pipe 100 when a temperature is low, and configured to restore the original state by being manually operated so that the open second discharge pipe 100 can be closed, and an electronic valve 120 installed at the second discharge pipe 100 below the temperature valve 110 in a discharge direction of the second discharge pipe 100, and set to close the second discharge pipe 100 when being supplied with power but to open the second discharge pipe 100 when the power supply is interrupted.

As shown in FIG. 4, if the freezing protection system of the present invention is in an on state, the second discharge pipe 100 is in a closed state by the electronic valve 120 when the fluid inside the heat exchanger 10 is discharged. Accordingly, the fluid inside the heat exchanger 10 may be discharged only through the discharge pipe 20.

As shown in FIG. 5, if the freezing protection system of the present invention is in an on state, the discharge pipe 20 is in a closed state by the discharge valve 30, and the second discharge pipe 100 is in a closed state by the electronic valve 120 at the time of charging a fluid in the heat exchanger 10. Accordingly, the fluid filled in the heat exchanger 10 does not leak through the discharge pipe 20 or the second discharge pipe 100.

As shown in FIG. 6, if the power supply to the freezing protection system of the present invention is interrupted, the discharge valve 30 is set to close the discharge pipe 20, and the electronic valve 120 is set to open the second discharge pipe 100. In this state, if the temperature becomes low enough to cause freezing of the heat exchanger 10, the temperature valve 110 is set to open the second discharge pipe 100. Accordingly, the fluid inside the heat exchanger 100 may be discharged through the second discharge pipe 100, not through the closed discharge pipe 20.

As shown in FIG. 7, if the freezing protection system of the present invention is in an on state again, the electronic valve 120 is re-set to close the second discharge pipe 100. Accordingly, even if the temperature valve 110 maintains the state set to open the second discharge pipe 100, without being manually set to close the second discharge pipe 100, the fluid filled in the heat exchanger 100 may not leak through the second discharge pipe 100. At the time of charging a fluid in the heat exchanger 10, the discharge pipe 20 may be closed by the discharge valve 30.

The heat exchanger to which the freezing protection system is applied may be utilized in an air conditioner having a heating or cooling function or a cleaning function. Especially, the heat exchanger may be very utilizable in an air conditioner used only in summer and not used in winter.

The heat exchanger may be configured as a hermetic cooling coil or a plume preventing coil. Therefore, the freezing protection system may be very utilizable in a cooling coil corresponding to the heat exchanger, or a cooling tower having a plume preventing coil.

For reference, the hermetic cooling coil or the plume preventing coil is a heat exchanger for heat-exchanging cooling water which flows in a hermetic cooling coil with the air outside the cooling coil. This may be advantageous in recycling cooling water used in a condenser of an industrial freezer, etc., or removing waste heat, or preventing a plume phenomenon.

The air conditioner, the hermetic cooling coil, the plume preventing coil and the cooling tower are well-known in technical fields of an air conditioner, etc., and thus detailed explanations thereof will be omitted.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A freezing protection system of a heat exchanger, the system comprising:
a discharge valve for opening and closing a discharge pipe of a fluid inside a heat exchanger;
a freezing factor detection unit for detecting a freezing factor such that the discharge pipe is open, under an automatic control of the discharge valve, upon detection of the freezing factor when the heat exchanger is in a standstill state; and
a discharge completion detection unit for detecting whether the fluid inside the heat exchanger has been completely discharge or not, such that the open discharge valve is closed under an automatic control of the discharge valve after the fluid inside the heat exchanger has been completely discharged.

2. The freezing protection system of a heat exchanger of claim 1, further comprising a ventilation unit for ventilating the heat exchanger when the fluid inside the heat exchanger is discharged.

3. The freezing protection system of a heat exchanger of claim 2, wherein the ventilation unit further includes an air vent valve configured to be open such that the heat exchanger is ventilated when the fluid inside the heat exchanger is discharged.

4. The freezing protection system of a heat exchanger of claim 3, wherein to the heat exchanger, connected are an inlet circulation pipe and an outlet circulation pipe through which the fluid for a heat exchange operation is introduced into or discharged from the heat exchanger,
wherein the inlet circulation pipe and the outlet circulation pipe are installed with an inlet blocking valve and an outlet blocking valve, respectively,
wherein the air vent valve is connected to one of the inlet circulation pipe and the outlet circulation pipe, and
wherein the discharge valve is connected to one of the inlet circulation pipe and the outlet circulation valve, the one to which the air vent valve has not been connected.

5. The freezing protection system of a heat exchanger of claim 2, wherein the discharge completion detection unit includes a heat exchanger inner pressure sensor for sensing an inner pressure of the heat exchanger in order to determine whether the fluid inside the heat exchanger has been completely discharged, by comparing the inner pressure of the heat exchanger with an atmospheric pressure when the fluid is discharged.

6. The freezing protection system of a heat exchanger of claim 1, wherein the discharge completion detection unit further includes a heat exchanger weight sensor for sensing a weight of the heat exchanger in order to determine, based on the weight of the heat exchanger, whether the fluid inside the heat exchanger has been completely discharged.

7. The freezing protection system of a heat exchanger of claim 2, wherein the discharge completion detection unit further includes a heat exchanger weight sensor for sensing a weight of the heat exchanger in order to determine, based on the weight of the heat exchanger, whether the fluid inside the heat exchanger has been completely discharged.

8. The freezing protection system of a heat exchanger of claim 1, wherein the discharge completion detection unit includes a level sensor for detecting a discharge flow of the fluid inside the heat exchanger.

9. The freezing protection system of a heat exchanger of claim 2, wherein the discharge completion detection unit includes a level sensor for detecting a discharge flow of the fluid inside the heat exchanger.

10. The freezing protection system of a heat exchanger of claim 1, wherein the freezing factor detection unit includes a heat exchanger temperature sensor for sensing at least one of an inner temperature and an outer temperature of the heat exchanger.

11. The freezing protection system of a heat exchanger of claim 2, wherein the freezing factor detection unit includes a heat exchanger temperature sensor for sensing at least one of an inner temperature and an outer temperature of the heat exchanger.

12. The freezing protection system of a heat exchanger of claim 1, further comprising a charging unit for supplying compressed air into the heat exchanger for ventilation, or charging a fluid in the heat exchanger for an operation of the heat exchanger from which the fluid has been discharged.

13. The freezing protection system of a heat exchanger of claim 2, further comprising a charging unit for supplying compressed air into the heat exchanger for ventilation, or charging a fluid in the heat exchanger for an operation of the heat exchanger from which the fluid has been discharged.

14. The freezing protection system of a heat exchanger of claim 1, wherein the discharge valve includes an automatic control valve configured to be automatically controlled when the system is in an on state, and set to close the discharge pipe when the system is in an off state.

15. The freezing protection system of a heat exchanger of claim 2, wherein the discharge valve includes an automatic control valve configured to be automatically controlled when the system is in an on state, and set to close the discharge pipe when the system is in an off state.

16. The freezing protection system of a heat exchanger of claim 1, further comprising:
a temperature valve installed at a second discharge pipe for guiding discharge of the fluid inside the heat exchanger, configured to open the second discharge pipe when a temperature is low enough to cause freezing of the heat exchanger when the system is in an off state, and configured to restore the original state by being manually operated such that the open second discharge pipe is closed; and
an electronic valve installed at the second discharge valve below the temperature valve in a discharge direction of the second discharge valve, and set to close the second discharge pipe when being supplied with power but to open the second discharge pipe when the power supply is interrupted.

17. The freezing protection system of a heat exchanger of claim 2, further comprising:
a temperature valve installed at a second discharge pipe for guiding discharge of the fluid inside the heat exchanger, configured to open the second discharge pipe when a temperature is low enough to cause freezing of the heat exchanger, and configured to restore to the original state by being manually operated such that the open second discharge pipe is closed; and
an electronic valve installed at the second discharge pipe below the temperature valve in a discharge direction of the second discharge pipe, and set to close the second discharge pipe when being supplied with power but to open the second discharge pipe when the power supply is interrupted.

18. The freezing protection system of a heat exchanger of claim 1, further comprising:
an air vent valve configured to be open such that the heat exchanger is ventilated when the fluid inside the heat exchanger is discharged;
a charging unit for supplying compressed air into the heat exchanger for ventilation, or charging a fluid in the heat exchanger for an operation of the heat exchanger from which the fluid has been discharged;
a temperature valve installed at a second discharge pipe for guiding discharge of the fluid inside the heat exchanger, configured to open the second discharge pipe when a temperature is low enough to cause freezing of the heat exchanger, and configured to restore the original state by being manually operated such that the open second discharge pipe is closed; and
an electronic valve installed at the second discharge pipe below the temperature valve in a discharge direction of the second discharge pipe, and set to close the second discharge pipe when being supplied with power but to open the second discharge pipe when the power supply is interrupted,
wherein the discharge valve includes an automatic control valve configured to be automatically controlled when the system is in an on state, and set to close the discharge pipe when the system is in an off state;
wherein the freezing factor detection unit includes a heat exchanger temperature sensor for sensing at least one of an inner temperature and an outer temperature of the heat exchanger; and
wherein the discharge completion detection unit includes:
a heat exchanger inner pressure sensor for sensing an inner pressure of the heat exchanger in order to determine whether the fluid inside the heat exchanger has been completely discharged, by comparing the inner pressure of the heat exchanger with an atmospheric pressure when the fluid is discharged;
a heat exchanger weight sensor for sensing a weight of the heat exchanger in order to determine, based on the weight of the heat exchanger, whether the fluid inside the heat exchanger has been completely discharged; and
a level sensor for detecting a discharge flow of the fluid inside the heat exchanger.

19. A method for controlling a freezing protection system of a heat exchanger of claim 1, the method comprising:
a circulation pipe closing step of closing a circulation pipe of a fluid inside a heat exchanger upon detection of a freezing factor of the heat exchanger due to a temperature of the heat exchanger, the fluid for a heat exchange operation;
a discharge pipe opening step of opening a discharge pipe such that the fluid inside the heat exchanger is discharged through the discharge pipe;
a differential pressure detecting step of firstly detecting a differential pressure between an inner temperature of the heat exchanger and an atmospheric pressure, and secondly detecting a differential pressure between an inner temperature of the heat exchanger and an atmospheric pressure, after a predetermined time has lapsed, when the firstly-detected differential pressure is less than a first reference value;
a ventilation step of ventilating the heat exchanger by supplying gas into the heat exchanger when the secondarily-detected differential pressure is more than a second reference greater than the first reference value;
a ventilation halt step of halting the ventilation when a thirdly-detected differential pressure between an inner temperature of the heat exchanger and an atmospheric pressure is less than a third reference value, or when a predetermined time long enough to perform the ventilation has lapsed; and
a discharge pipe closing step of fourthly detecting a differential pressure between an inner temperature of the heat exchanger and an atmospheric pressure, after a predetermined time has lapsed after the ventilation halt step, and closing the discharge pipe open in the discharge pipe opening step when the fourthly-detected differential pressure is less than a fourth reference value.

20. A method for controlling a freezing protection system of a heat exchanger of claim 18, the method comprising:
a circulation pipe closing step of closing a circulation pipe of a fluid inside a heat exchanger upon detection of a freezing factor of the heat exchanger due to a temperature of the heat exchanger, the fluid for a heat exchange operation;
a discharge pipe opening step of opening a discharge pipe such that the fluid inside the heat exchanger is discharged through the discharge pipe;
a differential pressure detecting step of firstly detecting a differential pressure between an inner temperature of the heat exchanger and an atmospheric pressure, and secondly detecting a differential pressure between an inner temperature of the heat exchanger and an atmospheric pressure, after a predetermined time has lapsed, when the firstly-detected differential pressure is less than a first reference value;
a ventilation step of ventilating the heat exchanger by supplying gas into the heat exchanger when the secondarily-detected differential pressure is more than a second reference greater than the first reference value;
a ventilation halt step of halting the ventilation when a thirdly-detected differential pressure between an inner temperature of the heat exchanger and an atmospheric pressure is less than a third reference value, or when a predetermined time long enough to perform the ventilation has lapsed; and
a discharge pipe closing step of fourthly detecting a differential pressure between an inner temperature of the heat exchanger and an atmospheric pressure, after a predetermined time has lapsed after the ventilation halt step, and closing the discharge pipe open in the discharge pipe opening step when the fourthly-detected differential pressure is less than a fourth reference value.
